(19) United States
(12) Patent Application Publication
(10) Pub. No.: US 2026/0196095 A1
(43) Pub. Date: Jul. 9, 2026

(54) ARCADE CONSOLE FLEX STAND

(71) Applicant: TIANZHI HUANG, Claremont, CA (US)

(72) Inventor: TIANZHI HUANG, Claremont, CA (US)

(21) Appl. No.: 19/026,052

(22) Filed: Jan. 16, 2025

(30) Foreign Application Priority Data
Jan. 3, 2025 (CN) 202520011879.3

(51) Int. Cl. G07F 17/32

(52) U.S. Cl. CPC G07F 17/3216

(57) ABSTRACT

A arcade console flex stand, includes a load-bearing frame, the load-bearing columns are fixedly connected between the load-bearing frames, arranged symmetrically inside the load-bearing frame. The side walls of the load-bearing columns are fixed with a first hinge seat. The ends of the load-bearing frame are welded with a fixed plate, the bottom of fixed plate is rotatably connected to a load-bearing rod. A support rod is connected between the load-bearing rods, positioned at the middle part of the load-bearing rods. The top of the support rod is fixedly connected to a second hinge seat. A folding rod is foldably connected between the first and second hinge seats. The interior of the folding rod is elastically connected to a spring.

### CROSS-REFERENCE TO RELATED APPLICATIONS

This application claims priority to Chinese Patent Application No. 202520011879.3, filed on Jan. 3, 2025, which is hereby incorporated by reference in its entirety.

### TECHNICAL FIELD

The present application relates to the technical field of multi-purpose portable stand, specifically to a arcade console flex stand.

### BACKGROUND

Traditional gaming console tables are mostly fixed furniture, they are large in size, bulky, and difficult to move or carry. These types of gaming console tables are typically designed for indoor use, lack flexibility, and are unable to meet the needs of players in outdoor, travel, or temporary gaming location scenarios. Furthermore, when storing these gaming console tables, a large amount of space is required, making them extremely inconvenient. For this purpose, we propose a arcade console flex stand.

### SUMMARY

Aiming at the deficiencies in the prior art, the present application provides a arcade console flex stand is proposed, the multi-functional folding design may make the arcade console flex stand quickly and easily folded, and the solid material selection may make the arcade console flex stand more firm and provide a stable operating platform for players.

### BRIEF DESCRIPTION OF DRAWINGS

FIG. 1 is a schematic diagram of the overall structure of the arcade console flex stand in the embodiment of the present application;

FIG. 2 is a side view of the arcade console flex stand in the embodiment of the present application;

FIG. 3 is the structural diagram of the telescopic column in the embodiment of the present application;

FIG. 4 is a structural diagram of the folding foot pads for the embodiment of the present application.

In the figures: 11,Load-bearing frame; 12,Load-bearing column;
13,First hinge seat; 14,Fixed plate; 15,Load-bearing rod; 16,Support rod;
17,Second hinge seat; 18,Folding rod; 19,Spring;21, Limit block;
31,Telescopic column; 41,Folding foot pads; 42,Screw;51,Limit hole;
52,Bolt;61,Anti-slip pad

### DESCRIPTION OF EMBODIMENTS

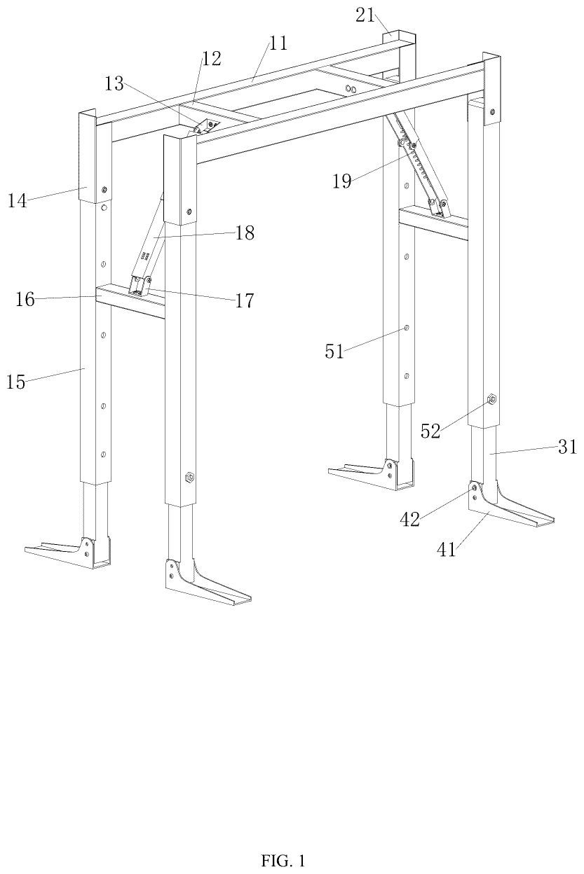

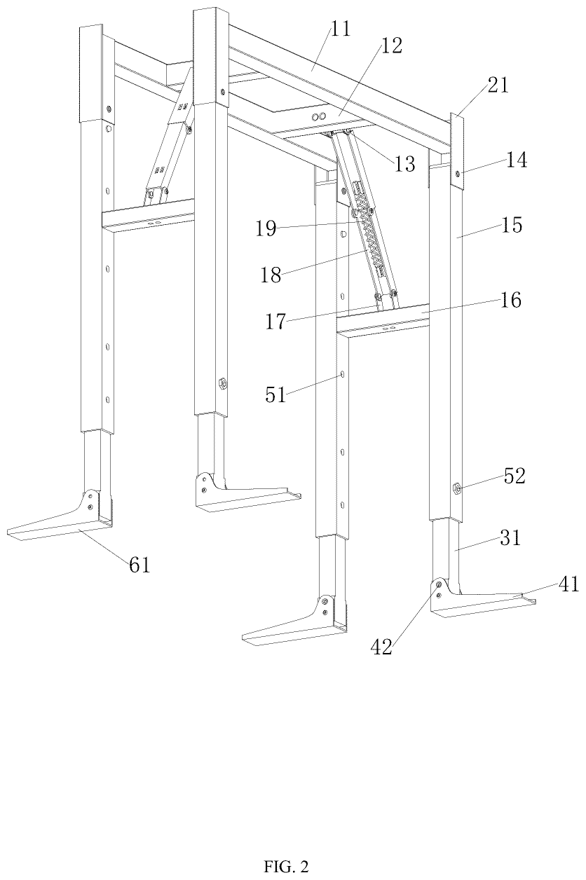

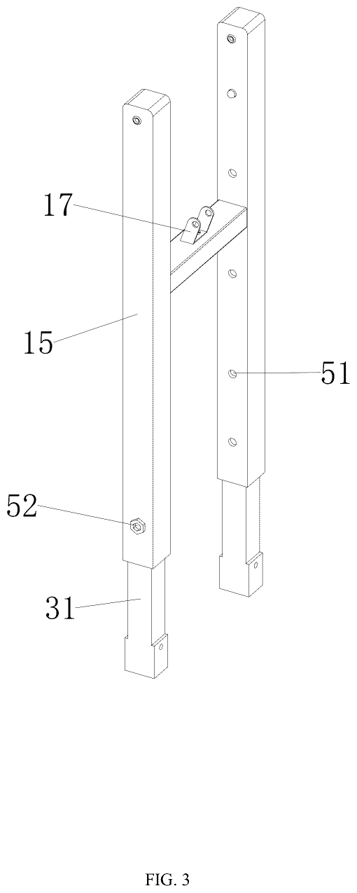

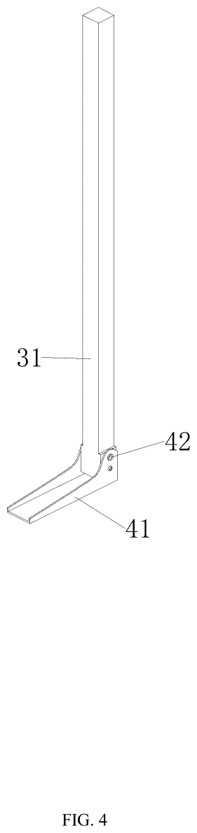

As shown in FIG. 1 to 4, the present application includes a load-bearing frame 11; load-bearing column 12 are fixed between the load-bearing frame 11; the load-bearing column 12 are symmetrically arranged within the load-bearing frame 11; the sidewalls of the load-bearing column 12 are fixed with first hinge seats 13; fixed plates 14 are welded to the ends of the load-bearing frame 11; the bottom of the fixed plate 14 is rotatably connected to load-bearing rod 15; support rods 16 are connected between the load-bearing rod 15; the support rods 16 are positioned at the middle of the load-bearing rod 15; the top of the support rods 16 is fixed with second hinge seats 17; a folding rod 18 is connected between the first hinge seat 13 and the second hinge seat 17; the inside of the folding rod 18 is elastically connected to a spring 19; When the arcade console flex stand needs to be used, it can be opened by means of a folding rod 18 connected between the first hinged seat 13 on the side wall of the load-bearing column 12 and the second hinged seat 17 on the side wall of the support rod 16. The gaming console and a console top can be placed on the load-bearing frame 11. When not in use, the arcade console flex stand can be folded for easier portability. The internal spring 19 provides elastic support, and the first hinge seat 13 and second hinge seat 17 allow the folding rod 18 to be folded, facilitating better folding and transport by users. Through this structure, the gaming console may be effectively fixed, providing a stable platform for placing gaming equipment, ensuring safety and stability during gameplay. This setup allows players to operate the gaming console more comfortably, minimizing inconveniences caused by shaking or other factors. Furthermore, when not in use for gaming, a console top may be placed on top of the device, converting stand into a study desk for users, making it more versatile. Additionally, the clever structure allows the inclusion of a limit block, it may meet the everyday storage needs of items such as hanging bags, keeping the items organized and easy to access.

The working principle of the above technical solution is as follows:

In another embodiment, a limit block 21 is fixed to the top of the fixed plate 14. The limit block 21 is positioned at the top of the load-bearing frame 11 and is symmetrically arranged. During operation, when the arcade console flex stand is required, the limit block 21 can be used to fix the gaming console. When not in use, a console top can be used to convert the stand into an ordinary desk. Additionally, the protruding limit block 21 can function as a hook, allowing other items to be hung. With this structure, the gaming console can be effectively secured, and when not needed, a console top on the frame can easily be converted into an ordinary desk, satisfying daily office or study needs. Furthermore, when not in use, the limit block 21 can serve as a hanging accessory for items such as storage bags, thus providing additional storage functionality.

In another embodiment, a telescopic column 31 is arranged at the bottom of the load-bearing rod 15. The telescopic column 31 is positioned inside the load-bearing rod 15 and is designed to be telescopic. During operation, when the arcade console flex stand is needed, the height of the stand can be adjusted by adjusting the telescopic column 31, allowing users to achieve a more comfortable sitting or standing posture. This structure allows for effective height adjustment of the stand according to user needs, facilitating a more comfortable operation whether sitting, standing, or using other positions. With this adjustable feature, the device accommodates users of varying heights, ensuring that users from different height ranges can adjust the stand to suit their needs, thereby enhancing the versatility and applicability of the device.

In another embodiment, the telescopic column 31 is provided with a folding foot pads 41. The folding foot pads 41 is located at the bottom of the telescopic column 31 and is connected by a screw 42, with a rotational arrangement. During operation, when the arcade console flex stand is in use, the folding foot pads 41 can be adjusted relative to the telescopic column 31 by adjusting the screw 42, thereby making the arcade console flex stand more level and stable, with a larger supporting area to enhance its stability. The above structure effectively increases the support area, significantly improving stability during operation, and providing a more stable and comfortable gaming experience.

In another embodiment, the load-bearing rod 15 is provided with a limit hole 51 on its side wall. A bolt 52 is engaged with the internal of the limit hole 51 on the side wall of the load-bearing rod 15, with the bolt 52 being arranged in a locking manner. During operation, when the arcade console flex stand needs to be adjusted in height, the bolt 52 can be engaged with the limit hole 51 to secure the height adjustment, preventing any unintended downward movement during use. The above structure effectively enables height adjustment of the arcade console flex stand by coordinating the limit hole 51 and the bolt 52.

In another embodiment, the bottom of the folding foot pads 41 is firmly attached to an anti-slip pad 61. The anti-slip pad 61 is positioned on the bottom of the folding foot pads 41 in a contact arrangement. During operation, when the arcade console flex stand is in use, the anti-slip pad 61 provides an anti-slip function, preventing the stand from moving on a slippery surface, and also contributing to its stability. The above structure effectively increases friction, preventing the gaming console, accessories, and the stand itself from sliding during use.

In another embodiment, the arcade console flex stand is made of iron material and is surface-coated with paint. During operation, when the arcade console flex stand needs to be folded, the load-bearing frame 11, it is a painted iron-frame structure, enhances the overall stability of the structure and prevents deformation during storage and placement. With this structure, the stand can effectively ensure a certain strength while also significantly reducing the overall weight and volume, thereby achieving the convenience of portability.

When the arcade console flex stand is in use, it can be opened by a folding rod 18, it connects the first hinge seat 13 on the sidewall of the load-bearing column 12 and the second hinge seat 17 on the sidewall of the supporting rod 16. The gaming console and console top can then be placed on the load-bearing frame 11. If not in use, the stand can be folded for easier portability. The internal spring 19 provides elastic support, and the first hinge seat 13 and second hinge seat 17 enable the folding rod 18 to achieve a folding effect, making it easier for users to fold and carry the stand. When the arcade console flex stand is in use, the gaming console can be fixed in place by a limit block 21. When not in use, the console top can be used to convert the stand into a regular desk, and the protruding limit block 21 can serve as a hook for hanging other items. When the arcade console flex stand is in use, the height can be adjusted via the telescoping column 31, making it more comfortable for users to switch between sitting and standing positions. To ensure a more stable and level surface, the folding foot pads 41 and telescoping column 31 can be adjusted via a screw 42, providing large-area support to enhance stability. For height adjustments, the limit hole 51 and bolt 52 can be used for secure coupling, preventing any unintended lowering during use. To prevent movement of the stand on slippery surfaces, anti-slip pads 61 can be applied, stabilizing the stand during use. When folding the arcade console flex stand, the entire structure, made from iron material and surface-coated with paint, ensures the overall stability of the frame and prevents deformation during storage and placement.

The beneficial effects of the embodiments are:
The arcade console flex stand mentioned may effectively ensure sufficient stability and multi-functional folding design. At the same time, through the setting of folding foot pads, the overall structure of the stand can be more convenient to fold and store. To provide players with a stable operating platform, through the stand has the function of height adjustment, users of different heights can be adjusted synchronously when using the stand, so that users of various height segments can be more compatible with the device, increasing the application of the device scenarios.

The arcade console flex stand of the embodiments may effectively fix the game console, provide a stable placing platform for the game equipment, ensure the safety and stability of the game process, facilitate the player to better operate the game console and reduce the inconvenience caused by shaking and other factors. At the same time, when not playing the game, a console top can be placed above the stand. Make it into a desk, convenient for users to learn, and the use of clever structure, may also allow the limit block to meet the daily needs of storage bags and other items hanging storage, so that the items are placed more orderly, easy to use.

The above embodiment merely illustrates specific implementation of the present application, described in detail and with particularity. However, it should not be construed as limiting the scope of the patent for this application. It should be noted that, for those skilled in the art, various modifications and improvements can be made without departing from the spirit and concept of the present application, all of which are within the protection scope of this application.

What is claimed is:

1. A arcade console flex stand, comprising a load-bearing frame; characterized in that: load-bearing column are fixedly connected between the load-bearing frames; the load-bearing columns are symmetrically arranged inside the load-bearing frames; a first hinge seat is fixedly connected to the sidewall of the load-bearing column; a fixed plate is welded to the end of the load-bearing frame; the bottom of the fixed plate is rotatably connected to a load-bearing rod; supporting rods are connected between the load-bearing rods; the supporting rods are located at the middle position of the load-bearing rods ; the top of the supporting rods is fixedly connected to a second hinge seat; a folding rod is foldably connected between the first hinge seat and the second hinge seat; a spring is elastically connected inside the folding rod.

2. The arcade console flex stand according to claim 1, characterized in that: the top of the fixed plate is rigidly connecting to a limit block; the limit block is locating at the top position of the load-bearing frame and is symmetrically arranging.

3. The arcade console flex stand according to claim 2, characterized in that: the bottom of the load-bearing rod is providing with a telescopic column; the telescopic column is arranging inside the load-bearing rod in a telescopic manner.

4. The arcade console flex stand according to claim 3, characterized in that: the telescopic column is providing with a folding foot pad; the folding foot pads is connecting to the bottom of the telescopic column by screws, and is arranging to rotate.

5. The arcade console flex stand according to claim 4, characterized in that: a limit hole is forming on the sidewall of the load-bearing rod; a bolt is engaging inside the limit hole on the sidewall of the load-bearing rod; the bolt is configuring on the sidewall of the load-bearing rod in a locking arrangement.

6. The arcade console flex stand according to claim 5, characterized in that: a anti-slip pad is firmly attaching to the bottom of the folding foot pads; the anti-slip pad is arranging to be in direct contact with the bottom of the folding foot pads.

7. The arcade console flex stand according to claim 6, characterized in that: the arcade console flex stand is made of iron material and coating with surface paint.
